(19) United States
(12) Patent Application Publication
(10) Pub. No.: US 2007/0200928 A1
(43) Pub. Date: Aug. 30, 2007

(54) Method and apparatus for automated video surveillance

(76) Inventors: Phelim Anthony O'Doherty, Castleknock (IE); Sean David McCarthy, Sandymount (IE); Patrick Joseph Smith, Ballybough (IE); Carlos Luna, Ranelagh (IE); John Joseph O'Kane, Baltinglass (IE); Fergus Taylor, Sligo (IE); Wayne Kearns, Bray (IE); Roger Hatfield, Dublin (IE)

Correspondence Address: Brian L. Michaelis;Brown Rudnick Berlack Israels LLP, One Financial Center, Box IP, Boston, MA, 02111, US

(21) Appl. No.: 11/705,280

(22) Filed: Feb. 12, 2007

Related U.S. Application Data
(60) Provisional application No. 60/772,623, filed on Feb. 13, 2006.

(51) Int. Cl. H04N 7/18

(52) U.S. Cl. 348/143

(57) ABSTRACT

A surveillance system for an ATM utilizing multiple cameras aimed at the user, the card slot, and surrounding areas is disclosed. The cameras are powered and begin to record images after a sensor is activated. The system maintains a buffer of recorded imagery such that when the sensors are activated, the video processing equipment can store a pre-defined amount of time before the sensor is activated. The buffer allows for the video capture of events just prior to the activation of the sensor. A time stamp and any other relevant data from the cameras may also be included with the stored recorded video.

### FIELD OF INVENTION

The present invention relates to video processing, more particularly, to a method and apparatus for automated video surveillance.

### BACKGROUND OF INVENTION

Video cameras are cheap, small, and versatile, able to be deployed with an ordinary PC for video capture, surveillance and automated detection. The possibilities and applications opened up by the availability of this technology have not been remotely exhausted, particularly in the development of modular, automated systems for the detection of predefined events. When the application is localized and the target to be recognized is well-defined and specific, the detection apparatus can be cheap, reliable and quickly adapted from a universal system template. With the hardware burden largely taken care of by generic components and interfacing, the system possibilities are determined more by an inventive approach to software design that emphasizes the role of the finished system. Multiple video devices can be targeted to perform limited tasks efficiently, rather than video being the centerpiece of a generalized system. This makes it more likely that system functions can be automated, reducing the involvement of human operators: there is no point in providing yet more CCTV footage with no-one to watch it. Real-time video processing in software, without the need for dedicated image-processing hardware, is capable of filtering a video feed for particular events that will trigger a further response, such as raising an alarm or initiating a recording. The design task now becomes oriented towards the trigger event: deciding what it should be, arranging a video system that will capture it and extracting the event, in software, from the video feed.

### BACKGROUND OF THE INVENTION

Automatic teller machines (ATMs) are subject to various modes of fraudulent attack, which often involve compromising the ATM so that it fraudulently collects users' card details even while the ATM continues to operate. Fake ATM cards can then be encoded with the collected details and used to withdraw money from the compromised ATM, or indeed any other ATM.

The weakness in the ATM's operation that allows this fraud to work is the exclusive reliance on the card's magnetic stripe. Other features of the card are not checked, making this a quick and simple fraud to perpetrate with any blank cards which contain a magnetic stripe. The fraud also relies upon deceiving the user into believing that the ATM is operating normally, by camouflaging whatever means has been employed to collect user information.

Typically the magnetic stripe data of a card is read fraudulently by placing a card-reader over the ATM's card-insert slot. Cards pass through the added reader on their way into the slot, and it records a copy of the magnetic stripe data. From the user's point of view the ATM functions normally. At some later point, the fraudster can recover the added reader which now contains details of all the cards which have been used in the ATM. These details can be downloaded from the reader and used to create ‘cloned’ ATM cards which can then be used in an ATM as if they were the real thing. In this way the crime yields untraceable hard currency for its perpetrator before the victim is even aware that a crime has occurred. An even safer option for the criminal is to use a wireless link to transmit card details from the magnetic stripe reader to a nearby receiver, removing the risk of returning to the ATM to recover the reader. In either case, a collection of blank magnetic stripe cards can be quickly written with the gathered data to be used immediately to withdraw cash; the whole operation can be carried out in a day, with the perpetrators moving on to a different ATM to repeat the operation. There is one major hurdle to be overcome in this fraud, however: the ATM user must enter a PIN to authorize use of their card. The criminal must either acquire or deduce the card's PIN in order to use it. It turns out that a PIN can be deduced from the magnetic stripe data, as it must be for an ATM to operate in a stand-alone mode, although it is not common for this to be attempted by fraudsters. Instead an additional reading device is used to compromise the number keypad of the ATM, so as to capture the user's PIN as it is entered during use. There are two main strategies for PIN capture. One is to video the PIN entry, using a miniature camera connected to a recording device or transmitting wirelessly. The movements of the user's fingers over the keypad can then be viewed to determine the PIN. The other is to affix a fake keypad over the genuine one, with keys that push through to the real pad. The fake keypad records key presses in memory, and is recovered along with the magnetic stripe reader. Again, the user does not notice the fake and the ATM operates normally.

This crime is highly successful, thanks to its relative simplicity and the difficulty of catching it in operation. Once committed, the criminals immediately have actual money, unlike online fraud which leaves traces and requires accounts for payment. Furthermore, they are able to move on before the crime is detected. Although it involves physically altering the ATM, most users are not able to recognize the disguised additional readers added to the ATM fascia, which are often well-made and blend in with the genuine ATM physical interface. A careful comparison with the look of a genuine ATM is needed to reveal that it has been compromised, and swift detection is needed to catch the crime during its commission.

### SUMMARY OF INVENTION

A method and apparatus for automated video surveillance of an area if interest, such as an automated teller machine (“ATM”), is presented. An embodiment of the present invention includes a plurality of video cameras aimed at a variety of focal points around the area of interest and video recording and processing equipment.

An embodiment of the present invention includes a surveillance system for an ATM utilizing multiple cameras aimed at the user, the card slot, the cash dispenser, the surrounding areas and internally in the card reader (to link the card used to the ATM user). The cameras are constantly powered and begin to record images after a sensor is activated. An embodiment of the present invention maintains a buffer of recorded imagery such that when the sensors are activated, the video processing equipment can store a pre-defined amount of time before the sensor is activated. The buffer allows for the video capture of events just prior to the activation of the sensor. A time stamp and any other relevant data from the cameras may also be included with the stored recorded video.

Another embodiment of the present invention uses image processing technology to compare images of the ATM equipment. A base image is taken and stored, before installation of the ATM, and a camera collects images of the machine on periodic intervals. In addition to the original image, the image processor creates a composite image built from several sample images to allow for subtle lighting changes during the course of a day (e.g. day time versus night time). The image processor then compares the newly acquired image to the original image/composite image, looking for differences in the appearance of the machine. Upon detection of a discernable alteration to the machine, security is notified and the machine ceases to function.

### DESCRIPTION OF DRAWINGS

The foregoing and other features and advantages of the present invention will be more fully understood from the following detailed description of illustrative embodiments, taken in conjunction with the accompanying drawings in which:

FIG. 1 shows a top-down view of an embodiment in accordance with the present invention;

FIG. 2 shows a side-view of an embodiment in accordance with the present invention; and

FIG. 3 shows a frontal view of an embodiment in accordance with the present invention.

### DETAILED DESCRIPTION

Detailed embodiments of the present invention are disclosed herein, however, it is to be understood that the disclosed embodiments are merely exemplary of the invention, which may be embodied in various forms. Therefore, specific functional details disclosed herein are not to be interpreted as limiting, but merely as a basis for the claims and as a representative basis for teaching one skilled in the art to variously employ the present invention in virtually any appropriately detailed embodiment.

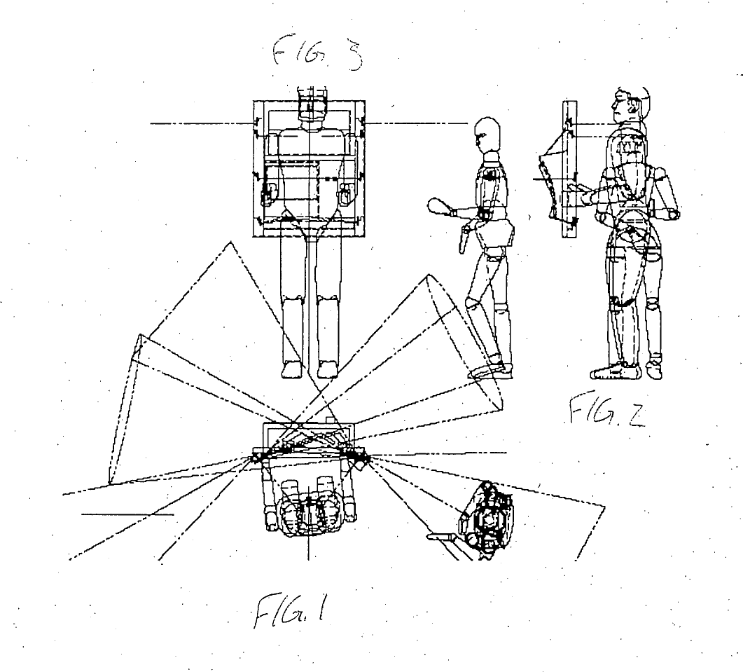

One embodiment of the invention allows for a number of cameras directed at specific aspects of the ATM and its surroundings. Some or all of these camera angles may be used in any particular implementation of the method. The range of possible camera positions, as shown in FIG. 1, includes a camera directed at the card slot in which a user would insert a bank card, a camera directed at a keypad, a cameras directed at the user from the upper left of ATM and from the upper right of ATM, and cameras directed to the nearby area to left of ATM and the nearby area to right of ATM.

In an embodiment of the present invention, cameras are activated by a passive sensor. In particular, the cameras which are pointed at the ATM user may be turned on by a passive infrared (“IR”) sensor which detects the presence of a person in front of the ATM. In an alternative embodiment, the cameras are activated by the insertion of a card in the ATM. The cameras remain constantly turned on and acquiring video. When the sensors are activated the camera video streams are collected and stored as a record in a computer's memory. The stored record is supplemented with a timestamp and any other relevant data.

An embodiment of the present invention allows for the capture of camera footage from a fixed period before activation to be included in the record. This includes in the record the video of a user approaching the ATM before inserting a bank card. The system always maintains a stored buffer of video of an appropriate length and commit it to the record along with the camera footage obtained after the sensors activate the cameras.

The cameras which are pointed at the ATM itself operate somewhat differently. In one embodiment, the cameras are looking for a permanent change in the appearance of the ATM, indicating that someone has tampered with the machine. Upon detection of a change, the system raises an alarm and either stores the video of the altered ATM appearance or transmits the live video to an operative to indicating an unauthorized change to the machine has occurred. An embodiment of the present invention provides for cameras pointing specifically at the ATM card slot and keypad, two areas with which are frequently tampered in a typical attack.

In one embodiment, the system must register, or learn how the ATM should normally appear. This is accomplished by capturing a still picture from each of the cameras pointed at an area of the ATM, e.g., the card slot and the key pad. The system now has a record of what the cameras should be seeing if the ATM has not been tampered with. These “normal” pictures can be captured during the initial setup or installation of the system. During operation of the system the cameras are constantly capturing new pictures of the ATM for comparison with the normal versions in memory. Image processing techniques, known in the art, are implemented to determine any changes in the images captured.

Although the embodiments described herein detail six cameras aimed at specific locations around an ATM, one skilled in the art should recognize that the present invention is not limited solely to the described embodiments. Other arrangements and numbers of cameras may be implemented without deviating from the scope of the invention.

Additionally, while the embodiments described herein detail an implementation of surveillance cameras in an ATM, one skilled in the art should recognize that any other areas in which security is a concern may be utilized, without deviating from the scope of the present invention.

While the invention has been described with reference to illustrative embodiments, it will be understood by those skilled in the art that various other changes, omissions and/or additions may be made and substantial equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A device for processing video comprising:
at video camera focused on an area of interest,
a sensor for detecting an event in the area of interest, and
a processor coupled to the camera and the sensor, the sensor signaling the processor upon detection of the event to capture the data collected by the camera.

2. The device of claim 1, wherein the processor records a buffer, the buffer added to the data collected by the camera.

3. The device of claim 1, wherein the data collected by the camera comprises a time stamp.

4. The device of claim 1, wherein the camera captures a first image of the area of interest, the processor comparing the first image to a second image, the second image captured by the camera at a time later than the capture of the first image.

5. A method of processing video comprising:
viewing an area of interest through a video camera;
storing a collection of data captured by a video camera upon the detection of an event in the area of interest by a sensor.

6. The method of claim 5, further comprising:
capturing a first image of the area of interest; and
comparing the first image to a second image of the area of interest, the second image captured at a time later than the capture of the first image.
